(19) United States
(12) Patent Application Publication
(10) Pub. No.: US 2006/0023739 A1
(43) Pub. Date: Feb. 2, 2006

(54) IEEE1394 connection apparatus

(76) Inventor: Isamu Ishimura, Kyotanabei-shi (JP)

Correspondence Address: MCDERMOTT WILL & EMERY LLP, 600 13TH STREET, N.W., WASHINGTON, DC, 20005-3096, US

(21) Appl. No.: 11/189,887

(22) Filed: Jul. 27, 2005

(30) Foreign Application Priority Data
Jul. 28, 2004 (JP) P2004-219646

(51) Int. Cl. H04L 12/66

(52) U.S. Cl. 370/463

(57) ABSTRACT

On a commercial product mounting substrate 100, an IEEE1394 controller LSI 101 and CPU 103 which controls the IEEE1394 controller LSI 101 are mounted. A built-in PHY 102 having two ports is mounted on the IEEE1394 controller LSI 101. In addition, an external PHY 105 having three ports is also mounted on the commercial product mounting substrate 100. One port of the built-in PHY 102 and one port of the external PHY 105 are connected with each other by wiring on the commercial product mounting substrate 100. Remaining one port of the built-in PHY 102 and remaining two ports of the external PHY 105 are connected to connectors A, B and C, respectively, by wiring on the commercial product mounting substrate 100, and as a result, the number of connectors of a commercial product becomes three.

### BACKGROUND OF THE INVENTION

1. Field of the Invention

This invention relates to a mounting technology of an IEEE1394 controller LSI in digital AV devices and personal computers in which IEEE1394 interfaces are mounted.

2. Description of the Related Art

In digital AV devices (DV camcorders, digital tuners, digital televisions, DVD recorders etc.) and personal computers of recent years, a mounting rate of an IEEE (Institute of Electrical and Electronics Engineers) 1394 interface connector is going up very much. Paying attention to the digital AV devices among them, a number of LSI manufacturers are producing IEEE1394 controller LSIs which incorporated PHY (Physical Layer Interface).

FIG. 1 shows a typical system configuration of a conventional digital AV device. By use of FIG. 1, a commercial product mounting substrate 100 of the conventional digital AV device will be described. On the commercial product mounting substrate 100 in the digital AV device, an IEEE1394 controller LSI on which built-in PHY 102 was mounted, and CPU 103 which controls the IEEE1394 controller LST 101 are mounted. In addition, two IEEE1394 ports are mounted on the built-in PHY 102 in FIG. 1, and it is possible to mount an IEEE1394 connector (hereinafter, referred to as connector), just as many as the number of the IEEE1394 ports. In sum, the digital AV device in FIG. 1 is to have two connectors.

In case that it is desired to increase connectors of the digital AV device to three pieces, there were two options in the past. One of the options is to newly develop the IEEE1394 controller LSI 101 on which the built-in PHY 102, on which three IEEE1394 ports were mounted, is mounted. The other of the options is to increase the total number of connectors in the form of an external hub of a commercial product, by purchasing an IEEE1394 hub which is already available in the market (e.g., see, JP-A-11-135209 publication).

Next, by use of FIG. 1, a control method of power consumption reduction of the IEEE1394 controller LSI will be described. The IEEE1394 controller LSI 101 has a connection detecting circuit and a power saving function. The connection detecting circuit outputs a Low signal to a CNA output terminal when it detects that at least one another device, which is in such a state that communication is available (hereinafter, referred to as active other device), is connected to the connector 104. In addition, the power saving function is a function for reducing power consumption by stopping all circuits except for the connection detecting circuit, when a High signal is inputted to a PWRDN input terminal.

CPU 103 monitors a signal on the CNA output terminal (CNA signal), and if it is a Low signal, supplies a Low signal as a signal on the PWRDN input terminal PWRDN signal), and thereby, releases power saving. In addition, if the CNA signal is a High signal, a High signal is supplied to the PWRDN input terminal, to realize a power saving state, and thereby, power consumption is reduced.

However, in the above-described conventional configuration, in case that it is desired to increase connectors of a digital AV device to three or more pieces, there were such circumstances that redevelopment of an IEEE1394 controller LSI becomes necessary, and there is a necessity of purchasing an external hub, and cost as a system increases to a large extent.

In addition, in case that an external hub was used, it is not possible to control a power saving function of the external hub, and therefore, there occurred such a problem that it is not possible to reduce power consumption as a system.

### SUMMARY OF THE INVENTION

The invention aims to provide an IEEE1394 connection apparatus which can increase connectors of a digital AV device to three or more pieces, without increasing cost as a system to a large extent.

The invention has first, second and third connectors which are connected to an external device, an IEEE1394 controller LSI which incorporates a physical layer interface having a first port and a second port which are connected to the first connector, and an external physical layer interface which has a third port which is connected to the second port, a fourth port which is connected to the second connector, and a fifth port which is connected to the third connector.

According to the above-described configuration, by connecting the external physical layer interface to the IEEE1394 controller LSI, it is possible to increase connectors of a digital AV device to three or more pieces, without increasing cost as a system to a large extent.

In addition, the invention has first, second, third and fourth connectors which are connected to an external device,
an IEEE1394 controller LSI which incorporates a physical layer interface having a first port and a second port which are connected to the first connector, a first external physical layer interface which has a third port which is connected to the second port, a fourth port and a fifth port which are connected to the second connector, and a second external physical layer interface which has a sixth port which is connected to the fifth port, a seventh port which is connected to the third connector, and an eighth port which is connected to the fourth connector.

According to the above-described configuration, by connecting the second external physical layer interface to the IEEE1394 controller LSI, it is possible to increase connectors of a digital AV device to four or more pieces, without increasing cost as a system to a large extent.

In the invention, the IEEE1394 controller LSI has CPU which controls power saving functions of the IEEE1394 controller LSI and the external physical layer interface. According to this configuration, by controlling the IEEE1394 controller LSI and the external physical layer interface to control power saving function to all connectors, it is possible to reduce power consumption of an entire system.

In the invention, in case that an external device is connected to the first connector and an external device is not connected to the second and third connectors, the CPU turns the external physical layer interface into a power saving state. According to this configuration, by turning the external physical layer interface into a power saving state in case that an external device is not connected to the second and third connectors, it is possible to reduce power consumption of an entire system.

In the invention, in case that an external device is connected to the first connector and an external device is not connected to the second and third connectors, the CPU turns the IEEE1394 controller LSI into a power saving state, in case that it judged that communication with the external device, which was connected to the second and third connectors, is unnecessary. According to this configuration, by turning the IEEE1394 controller LSI into a power saving state in cse that an external device is not connected to the first connector, it is possible to reduce power consumption of an entire system.

In addition, the invention has CPU which controls power saving functions of the IEEE1394 controller LSI and the first and second external physical layer interfaces, and the CPU decouples topology by turning the first external physical layer interface into a power saving state. According to this configuration, by turning the first external physical layer interface into a power saving state to decouple topology, it is possible to secure sufficient transfer speed in each topology.

In addition, in the invention, the IEEE1394 controller LSI and the external physical layer interface are mounted on the same substrate, and connected by substrate wiring. According to this configuration, by mounting the IEEE1394 controller LSI and the external physical layer interface on the same substrate and connecting them by substrate wiring, it is possible to suppress cost increase as a system.

According to the invention, by mounting both of an IEEE1394, on which a built-in PHY was mounted, and an external PHY on a commercial product mounting substrate and by connecting one port of the built-in PHY and one port of the external PHY, it is possible to easily increase the number of connectors which are desired to be mounted, at low cost, without limitation due to the number of ports of the built-in PHY.

In addition, by CPU controlling power saving functions of both the IEEE1394 controller LSI and the external PHY, it is possible to realize low power consumption even if the number of connector is increased.

Further, in case that an active other device was connected only to a connector which corresponds to a port of the built-in PHY which is mounted on the IEEE1394 controller LSI, by controlling an external PHY to which the other device is not connected, to a power saving state, it is possible to reduce power consumption.

In addition, in case that a plurality of active other devices are connected only to a connector which corresponds to a port of external PHY and communication is carried out between other devices mutually, and in case that the plurality of other devices were devices which do not require communication with a commercial product which mounts an IEEE1394 connection apparatus of the invention, by controlling an IEEE1394 controller LSI on which built-in PHY is mounted, to a power saving state, it is possible to reduce power consumption.

### BRIEF DESCRIPTION OF THE DRAWINGS

FIG. 1 is a typical system configuration of a conventional digital AV device.

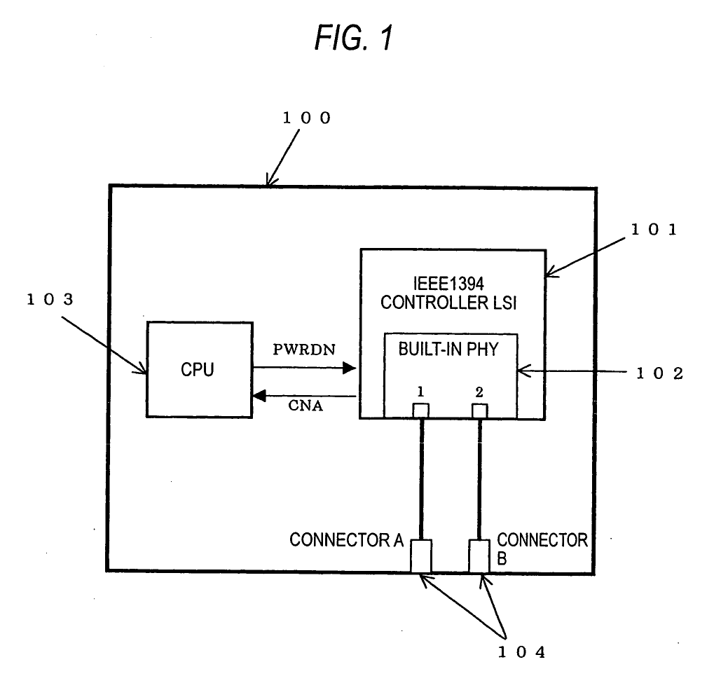

FIG. 2 is a system block diagram of an IEEE1394 connection apparatus which relates to an embodiment of the invention.

FIG. 3 is explanatory view of a power saving state in case that an other device was connected only to a connector A, in the embodiment of the invention.

FIG. 4 is an explanatory view of a power saving state in case that an other device was connected only to connectors B, C, in the embodiment of the invention.

FIG. 5 is an explanatory view of such a case that a power saving function is utilized and topology is decoupled, and thereby transfer of an IEEE1394 bus is made efficient.

FIG. 6 is a flow chart for explaining a transfer control method of an IEEE1394 bus by an IEEE1394 connection apparatus of this embodiment.

### DESCRIPTION OF THE PREFERRED EMBODIMENTS

Hereinafter, embodiments of the invention will be described in detail with reference to drawings. However, a technical scope of the invention is not restricted by these embodiments.

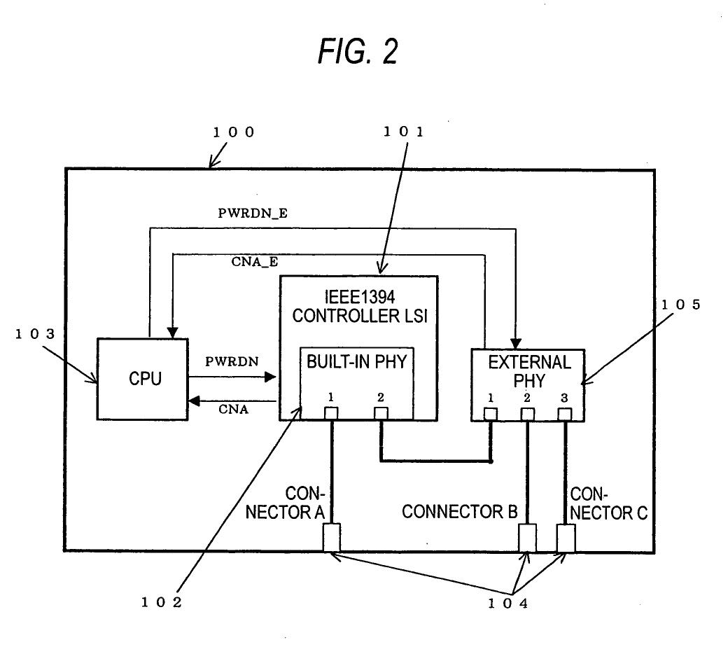

FIG. 2 is a system block diagram of an IEEE1394 connection apparatus which relates to an embodiment of the invention. 100 designates a commercial product mounting substrate such as a digital AV device on which an IEEE1394 interface was mounted. On the commercial product mounting substrate 100, an IEEE1394 controller LSI 101 and CPU 103 which controls the IEEE1304 controller LSI are mounted. A built-in PHY 102 (physical layer interface) having two ports is mounted on the IEEE1394 controller LSI 101. In addition, an external PHY 105 (external physical layer interface) having three ports is mounted on the commercial product mounting substrate 100.

One port (second port) of the built-in PHY 102 and one port (third port) of the external PHY 105 are mutually connected by wiring on the commercial product mounting substrate 100. Remaining one port (first port) of the built-in PHY 102 and remaining two ports (fourth, fifth ports) of the external PHY 105 are connected to connectors A, B, C (first, second, third connectors) respectively, by wiring on the commercial product mounting substrate 100, and as a result, the number of connectors of a commercial product becomes three.

Successively, power saving will be described by use of FIG. 2. The IEEE1394 controller LSI 101 has a connection detecting circuit and a power saving function, and the connection detecting circuit outputs a Low signal to a CNA output terminal when it detects that at least one active other device was connected to the connector A. In addition, the power saving function is a function for stopping all circuit except for the connection detecting circuit when a High signal is inputted to a PWRDN input terminal, to reduce power consumption.

CPU 103 monitors the above-described CNA signal, and if it is a Low signal, supplies a Low signal as the above-described PWRDN signal, and thereby, releases power saving. In addition, if the CNA signal is a High signal, a High signal is supplied as the PWRDN signal, to realize a power saving state, and thereby, power consumption is reduced.

The external PHY 105 also has a connection detecting circuit and a power saving function, in the same manner, and the connection detecting circuit outputs a Low signal to a CAN_E terminal when it detects that at least one active other device was connected to the connector B or C. In addition, the power saving function is a function for stopping all circuit except for the connection detecting circuit when a High signal is inputted to a PWRDN_E input terminal, to reduce power consumption.

CPU 103 monitors a signal on the CNA_E output terminal (CAN_E signal), and if it is a Low signal, supplies a Low signal as a signal on the PWRDN_E input terminal (PWRDN_E signal), and thereby, releases power saving. In addition, if the CAN_E signal is a High signal, a High signal is supplied to the PWRDN input terminal, to realize a power saving state, and thereby, power consumption is reduced.

In such a state that another device is not connected to any one of the connectors A, B and C, CPU 103 supplies a High signal as both of the PWRDN and PWRDN_E signals, and thereby, power consumption is reduced.

When another device is connected to any one of the connector, A, B, and C, the CAN or CNA_E signal changes from High to Low, and by use of this change as a trigger, CPU 103 supplied a Low signal as the PWRDN and PWRDN_E signals, and thereby, the power saving state is released and it turns into such a state that communication is available.

This embodiment was explained in such a manner that the number of ports of the built-in PHY is two ports, and the number of ports of the external PHY is three ports, but in the invention, respective port numbers are not restricted to them. In addition, this embodiment was explained in such a manner that one port of the built-in PHY and one port of the external PHY are connected by wiring on the commercial product mounting substrate, but there is no problem even if connectors are mounted on them, respectively, and they are connected by an IEEE1394 cable.

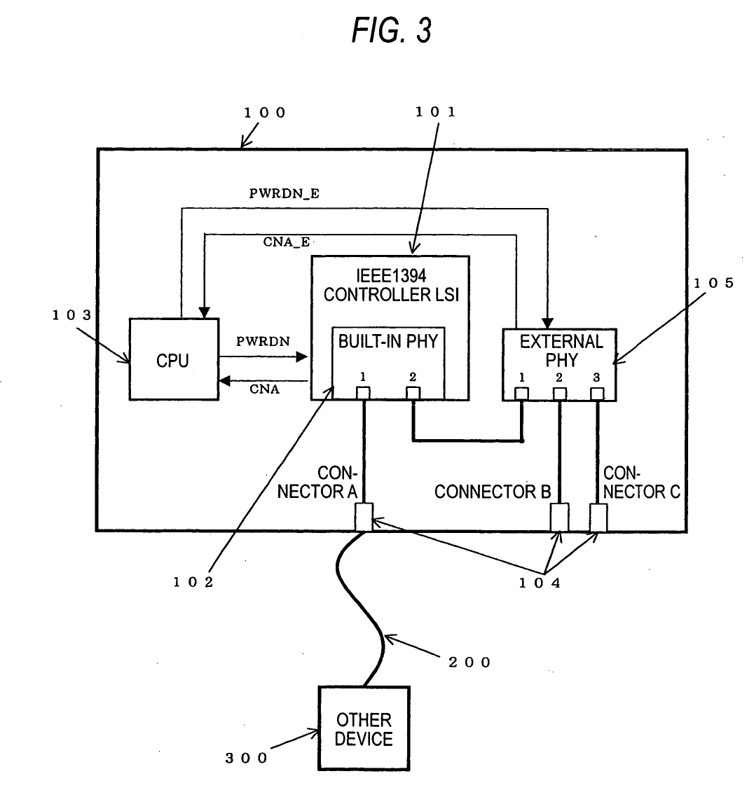

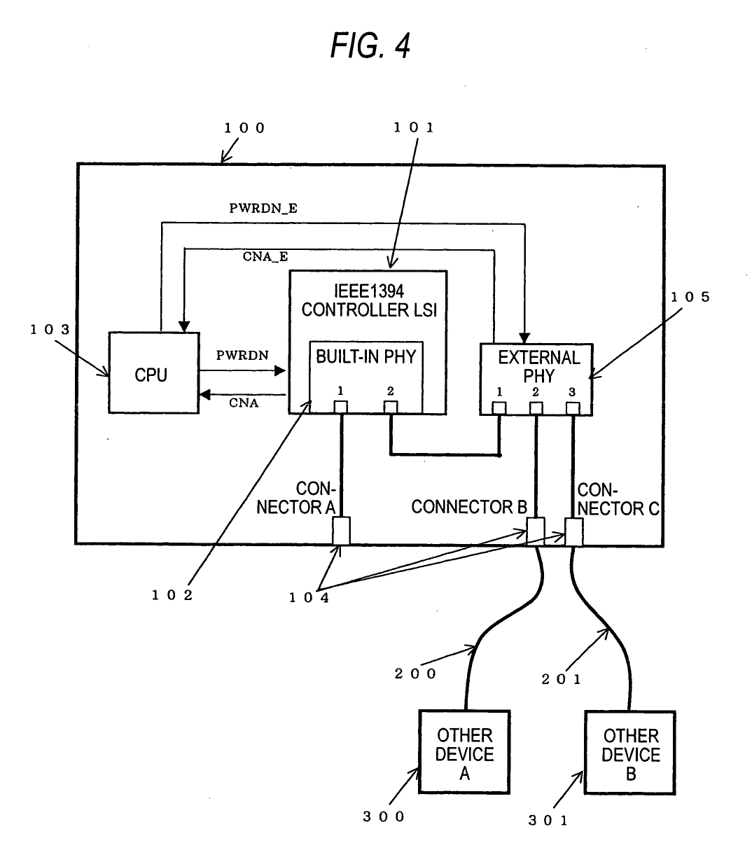

Next, by use of FIGS. 3 and 4, further detailed control of power saving will be described.

(Case that Other Device was Connected to Connector A)

FIG. 3 is an explanatory view of such a case that an active other device 300 was connected to the connector A through an IEEE1394 cable 200. Since the connector A is connected to a port of the built-in PHY 102, the CNA signal changes from High to Law. However, since an active other device is not connected to the connectors B and C which were connected to ports of the external PHY 105, CNA_E does not change.

In this case, CPU 103 supplies a Low signal as the PWRDN signal, and supplies a High signal as the PWRDN_E signal, and thereby, the IEEE1394 controller LSI 101 comes into a power saving release state, and the external PHY 105 comes into a power saving state. In this manner, in case that an active other device was connected only to the connector A, it is possible to reduce power consumption of the external PHY 105.

(Case that Other Device was Connected to Connectors B and C)

FIG. 4 is an explanatory view of such a case that an active other device A 300 was connected to the connector B through the IEEE1394 cable 200 and further, an active other device B 301 was connected to the connector C through an IEEE1394 cable 201. In this case, it is assumed that the other device A 300 and the other device B 301 are communicating with each other, and there is no necessity for the commercial product mounting substrate to communicate with any one of the other device A 300 and the other device B 301.

It is possible to judge a necessity of communication as a result of CPU 103 communicating with both of the other device A 300 and the other device B 301 through the IEEE1394 controller LSI 101 and the external PHY 105. For example, conceivable is such a case that the commercial product mounting substrate 100 is a digital television, and the other device A 300 is a personal computer, and the other device B 301 is a storage device, and communication is carried out only between the personal computer and the storage device. In this case, CPU 103 reads out a content of Configuration ROM in the other device A 300 and the other device B 301, and confirms that an AV protocol layer is not mounted on both of the other device A 300 and the other device B 301, and thereby, it is possible to judge a necessity of subsequent communication.

In case that CPU 103 judged that communication with any one of the other device A 300 and the other device B 301 is unnecessary, CPU 103 supplies a High signal as the PWRDN signal, and supplies a Low signal as the PWRDN_E signal, and thereby, only the IEEE1394 controller LSI comes into a power saving state. Since the external PHY 105 does not come into a power saving state, the other device A 300 and the other device B 301 can continue communication with each other.

In this manner, in case that an active other device was connected only to the connectors B and C, and in case that there is not such a necessity that the commercial product mounting substrate 100 communicates with the other devices, respectively, it is possible to reduce power consumption of the IEEE1394 controller LSI 101.

From the above-described explanation, it is understood that, in case that an other device is connected only to the connector A, it is possible to turn the external PHY 105 into a power saving state, and on one hand, in case that an other device is connected to one or both of the connectors B and C, it is possible to turn the IEEE1394 controller LSI into a power saving state after it was confirmed that there is no communication with the other device. Therefore, in case of connecting an active other device which requires communication with the commercial product mounting substrate 100, there is such a higher possibility that it is possible to reduce power consumption as a whole, in case that it is connected to the connector A and the external PHY is turned into a power saving state, than in other cases. Then, in the commercial product mounting substrate 100, by displaying such a matter that it is connected to the connector A on a preferential basis by use of any display function such as a sticker and printing, or describing on a user manual etc. that it is connected to the connector A on a preferential basis, it is possible to urge power consumption reduction of an entire system.

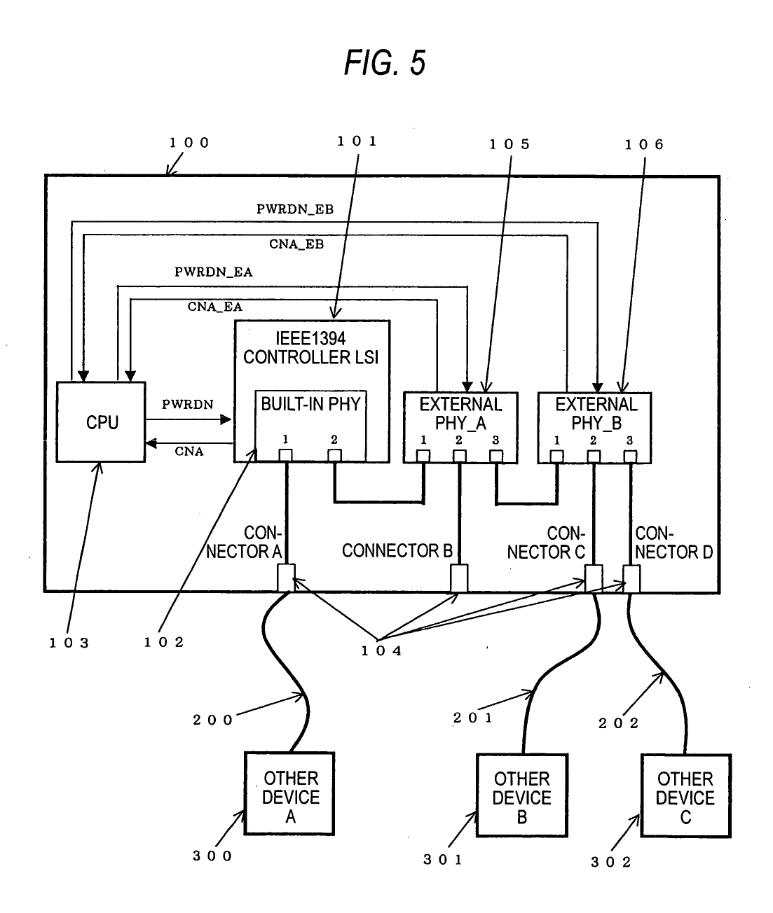

Next, a transfer control method of an IEEE1394 bus will be described. FIG. 5 is an explanatory view of such a case that transfer of an IEEE1394 bus is made more efficient by utilizing a power saving function and decoupling topology. In FIG. 5, an external PHY_B 106 having three ports (second external physical layer interface) is mounted in addition to the configuration of FIG. 2, and one port (fifth port) of an external PHY_A 105 (first external physical layer interface) is connected to one port (sixth port) of an external PHY_B 106 mutuall by wiring on the commercial product mounting substrate 100. As a result of this, a commercial product realizes mounting of total four connectors of the connectors A, B, C, and D (first, second, third, fourth connectors).

Power savings of the external PHY_A 105 and the external PHY_B 106 are controlled by CPU 103 by use of CNA_EA/PWRDN_EA signal, CNA_EB/PWRDN_EB signal, respectively, in the same manner as in FIG. 2.

In addition, in FIG. 5, the active other device A 300 is connected to the connector A through the IEEE1394 cable 200, and further, the active other device B 301, and other device C 302 are connected to the connectors C and D, through IEEE1394 cables 201 and 202, respectively.

Under the suchlike circumstance in which a number of devices exists within topology of IEEE1394 bus connection and communicates with each other, there occurs such a case that it is congested on the IEEE1394 bus and it is not possible to secure sufficient transfer speed. In such a case, under a specific condition, by turning the external PHY_A 105 in FIG. 5 into a power saving state to decouple topology, it is possible to sufficiently secure transfer speed within respective decoupled topologies. Hereinafter, the condition and a control procedure will be described.

As a condition, the other device A 300 requires communication only with the commercial product mounting substrate 100, and is connected to the connector A. In addition, the other device B 301 and the other device C 302 communicate with each other, and both of them do not require communication with the commercial product mounting substrate 100, and the other device B 301 and the other device C 302 are connected to the connectors C and D.

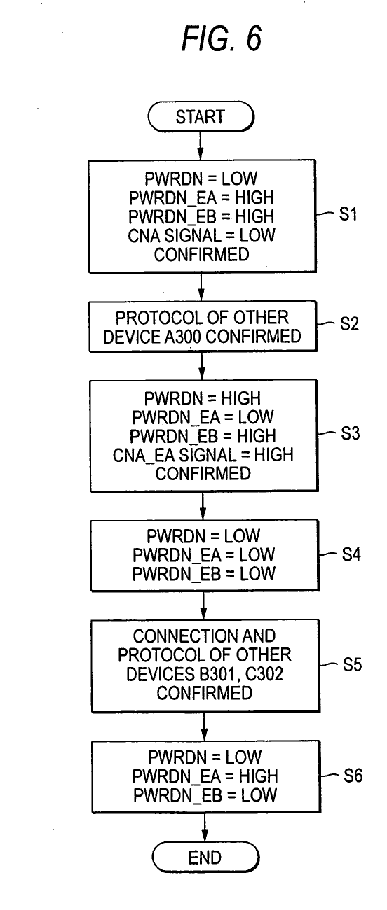

FIG. 6 is a flow chart for explaining a transfer control method of an IEEE1394 bus by an IEEE1394 connection apparatus of this embodiment. As shown in FIG. 6, firstly, CPU 103 supplies as the PWRDN signal, and releases the IEEE1394 controller LSI 101 from a power saving state. In addition, it supplies a High signal on PWRDN_EA and PWRDN_EB, to turn the external PHY_A 105 and the external PHY_B 106 into power saving states. After that, it confirms that the CNA signal is of Low, and confirms that the active other device A 300 is connected to the IEEE1394 controller LSI 101 (step S1).

Next, CUP 103 reads out a content of Configuration ROM of the other device A 300 which is connected, and confirms that the same protocol as that of the commercial product mounting substrate 100 is installed (step S2).

Next, CPU 103 supplies a Low signal as the PWRDN_EA signal and releases the external PHY_A 10t from a power saving state. In addition, it supplies a High signal on PWRDN and PWRDN_EB, and turns the IEEE1394 controller LSI 101 and the external PHY_B 106 into power saving states. After that, it confirms that the CNA_EA signal is of High, and confirms that an active other device is connected to the external PHY_A 105 (step S3).

Next, CPU 103 supplies Low signals as PWRDN, PWRDN_EA and PWRDN_EB signals, and releases the IEEE1394 controller LSI 101, the external PHY_A 105 and the external PHY_B 106 from power saving states (step S4).

Then, CPU 103 reads out a content of Configuration ROM of all other devices which are connected, and confirms that the other device B 301 and the other device C 302 are connected besides the other device A 300 which was confirmed in the step S2, and the same protocol as that of the commercial product mounting substrate 100 is not installed in the other device B 301 and the other device C 302 (step S5).

By the above-described control, it is possible to confirm that there is a necessity of communicating with the other device A 300 and there is no necessity of communication with the other device B 301 and the other device C 302.

Then, CPU 103 supplies Low signals as the PWRDN and PWRDN_EB signals, and releases the IEEE1394 controller LSI 101 and the external PHY_B 106 from power saving states. In addition, it supplies a High signal on PWRDN_EA, and turns the external PHY_A 105 into a power saving state (step S6).

By this means, “such topology that the commercial product mounting substrate 100 and the other device A 300 were connected” and “such topology that the other device B 301 and the other device C 302 were connected” are decoupled. As above, by decoupling topology, it is possible to secure sufficient transfer speed in each topology.

An IEEE1394 connection apparatus of the invention has such an advantage that it is possible to easily increase the number of connectors which are desired to be mounted, at low cost, without limitation of the number of ports of a built-in PHY, by mounting both of an IEEE1394 controller on which a built-in PHY was mounted and an external PHY and connecting one port of the built-in PHY and one port of the external PHY, and is useful as a mounting technology etc. of an IEEE1394 controller LSI in digital AV devices and personal computers on which IEEE1394 interfaces are mounted.

1. An IEEE1394 connection apparatus, comprising:
first, second and third connectors, which are connected to an external device;
an IEEE 1394 controller LSI, which incorporates a physical layer interface having a first port and a second port which are connected to the first connector; and
an external physical layer interface, which has a third port which is connected to the second port, a fourth port which is connected to the second connector, and a fifth port which is connected to the third connector.

2. An IEEE1394 connection apparatus, comprising:
first, second, third and fourth connectors, which are connected to an external device;
an IEEE1394 controller LSI which incorporates a physical layer interface having a first port and a second port which are connected to the first connector;
a first external physical layer interface, which has a third port which is connected to the second port, a fourth port and a fifth port which are connected to the second connector; and
a second external physical layer interface, which has a sixth port which is connected to the fifth port, a seventh port which is connected to the third connector, and an eighth port which is connected to the fourth connector.

3. The IEEE 1394 connection apparatus according to claim 1, further comprising:
a CPU, which controls power saving functions of the IEEE1394 controller LSI and the external physical layer interface.

4. The IEEE1394 connection apparatus according to claim 1, wherein: in case that an external device is connected to the first connector and an external device is not connected to the second and third connectors,
the CPU turns the external physical layer interface into a power saving state.

5. The IEEE1394 connection apparatus according to claim 3, wherein in case that an external device is connected to the first connector and an external device is not connected to the second and third connectors;
the CPU turns the IEEE1394 controller LSI into a power saving state, in case that it judged that communication with the external device, which was connected to the second and third connectors, is unnecessary.

6. The IEEE1394 connection apparatus according to claim 2, further comprising:
a CPU, which controls power saving functions of the IEEE 1394 controller LSI and the first and second external physical layer interfaces;
wherein the CPU decouples topology by turning the first external physical layer interface into a power saving state.

7. The IEEE1394 connection apparatus according to claim 1, wherein the IEEE1394 controller LSI and the external physical layer interface are mounted on the same substrate, and connected by substrate wiring.

8. The IEEE1394 connection apparatus according to claim 3, wherein the external physical layer interface and the IEEE1394 controller LSI have a function for detecting that an external device is connected to a port which each of the external physical layer interface and the IEEE1394 controller LSI includes; and
the CUP detects a non-connection state by the connection detecting function so as to turn the external physical layer interface or the IEEE1394 controller LSI into a power saving state.

9. The IEEE1394 connection apparatus according to claim 1, wherein display showing that an external device is connected to the first connector on a preferential basis, is carried out.

10. The IEEE 1394 connection apparatus according to claim 2, wherein display showing that an external device is connected to the first connector on a preferential basis, is carried out.

11. The IEEE1394 connection apparatus according to claim 4, wherein the external physical layer interface and the IEEE1394 controller LSI have a function for detecting that an external device is connected to a port which each of the external physical layer interface and the IEEE1394 controller LSI includes; and
the CUP detects a non-connection state by the connection detecting function so as to turn the external physical layer interface or the IEEE1394 controller LSI into a power saving state.

12. The IEEE1394 connection apparatus according to claim 5, wherein the external physical layer interface and the IEEE 1394 controller LSI have a function for detecting that an external device is connected to a port which each of the external physical layer interface and the IEEE1394 controller LSI includes; and
the CUP detects a non-connection state by the connection detecting function so as to turn the external physical layer interface or the IEEE1394 controller LSI into a power saving state.

13. The IEEE1394 connection apparatus according to claim 6, wherein the external physical layer interface and the IEEE1394 controller LSI have a function for detecting that an external device is connected to a port which each of the external physical layer interface and the IEEE1394 controller LSI includes; and
the CUP detects a non-connection state by the connection detecting function so as to turn the external physical layer interface or the IEEE 1394 controller LSI into a power saving state.
